(19) United States
(12) Patent Application Publication
(10) Pub. No.: US 2024/0255610 A1
(43) Pub. Date: Aug. 1, 2024

(54) COMPUTING TECHNOLOGIES FOR DETECTING AND TRACKING SPACE OBJECTS VIA COMBINATIONS OF INCOHERENT PROCESSING, DYNAMIC DETECTION, AND COHERENT AND/OR CORRELATOR PROCESSING

(71) Applicant: LeoLabs, Inc., Menlo Park, CA (US)

(72) Inventors: Matthew Stevenson, San Jose, CA (US); James Rowland, Mountain View, CA (US); Michael Nicolls, Portola Valley, CA (US); Benjamin Lichtenwalter, Columbia, MD (US)

(21) Appl. No.: 18/290,382

(22) PCT Filed: May 10, 2022
(86) PCT No.: PCT/US2022/028613

§ 371 Date: Nov. 13, 2023

Related U.S. Application Data
(60) Provisional application No. 63/188,208, filed on May 13, 2021.

(51) Int. Cl. G01S 7/288; G01S 7/40; G01S 13/522

(52) U.S. Cl. CPC G01S 7/2883; G01S 7/4021; G01S 13/522

(57) ABSTRACT

Various radar systems and methods may be capable of identifying and thereafter tracking objects, particularly objects not previously identified, moving in space through various combinations of incoherent processing of radar data, dynamic detection and modeling, and coherent and/or correlator processing. These radar systems and methods may do this without or while minimizing at least some computational expense that may be required by conventional radar systems and methods.

### CROSS-REFERENCE TO RELATED PATENT APPLICATION

This patent application claims a benefit of priority to U.S. Provisional Patent Application 63/188,208 filed 13 May 2021; which is incorporated by reference herein for all purposes.

### TECHNICAL FIELD

Generally, this disclosure relates to various computing technologies for detection and tracking of space objects. More particularly, this disclosure provides for various combinations of dynamic detections and incoherent, coherent and/or correlator processing of radar data to improve various processes of identifying and subsequently tracking moving objects in space, including objects that are initially unidentified.

### BACKGROUND

Pulse radar systems can be broadly categorized as coherent systems or incoherent systems, depending on the transmitter(s) and receiver(s) that are employed in the system. In coherent radar systems, the transmitter generates radar pulses that are phase-stable, continuous oscillations. When the radar pulses are received and processed, phase is maintained. In incoherent radar systems, the transmitter generates radar pulses, such that each pulse may have a random phase shift. When the radar pulses are received and processed, phase can be ignored.

Both coherent and incoherent radar systems have their advantages and disadvantages. For example, incoherent systems are typically faster in terms of processing. That is, processing radar pulses can be achieved more quickly than processing radar pulses in coherent systems. However, some signal-to-noise ratios in incoherent radar systems is typically lower than with coherent systems and, thus, radar returns that include target (object) data may be more difficult to detect and identify.

Correlator processing of radar signals is somewhat similar to coherent processing of radar signals in that phase information is maintained. In addition, correlator processing uses separate (more than one) receivers and correlates the signals across these receivers to achieve precise angular measurements in addition to range and Doppler shift measurements. Correlation processing may require an even greater processing load than does coherent processing.

In radar systems that are employed for identifying and tracking moving space objects, Doppler shift may be an important concept. Doppler shift refers to the change in the frequency of radio waves when the radio waves reflect off a moving object. As the velocity of the object changes, the Doppler shift changes proportionally. Thus, the ability to detect and quantify a Doppler shift and Doppler acceleration (changed in Doppler shift) associated with a moving object can be used to identify the moving object, as well as previously unidentified objects, based on range, velocity and acceleration, and used thereafter to track the moving object.

If an object has been previously identified, i.e., identified in advance, and the range, velocity and acceleration of the object are known, then Doppler shift and acceleration can more easily be used to spot and track the known object. In contrast, when an object is unknown, the process of identifying and thereafter tracking the object is a more complex proposition. That is because there may be a need to first search for and identify the unidentified object(s), and this may involve searching an entire spectrum of expected ranges, velocities and accelerations over a very small time interval, which is a computationally intense operation.

Therefore, this disclosure technologically improves various processes described above in identifying and thereafter tracking objects, particularly objects not previously identified, moving in space through various combinations of incoherent, coherent and/or correlator processing techniques, as well as data analysis and fitting to identify and track objects more accurately, without the computational expense mentioned above.

### SUMMARY

This disclosure may be embodied in various ways and can be generally summarized with reference to FIG. 1, which illustrates a number of illustrative processing steps. Each of these steps will be described, along with other aspects of the disclosure, in greater detail below.

In a first processing step 100, incoherent radar pulses from raw radar data are processed, over a series of time intervals, in accordance with incoherent processing techniques. Incoherent processing of radar data can be accomplished more quickly, as stated above, even though the signal-to-noise ratio of the return signals tends to be relatively low. Speed may be essential at this stage because there may be a need to sweep through a number of ranges to target and radial velocities to hopefully receive radar returns that include radar data related to a moving object(s). Because there may be no phase correlation with incoherent radar processing, some phase data associated with the incoherent radar pulses can be ignored, which may be one of several reasons incoherent processing is faster.

In a second processing step 200, referred to herein as dynamic processing, the incoherent radar data is analyzed by a measurement grouping and dynamical fitting algorithm(s) that measure the incoherent radar data and look for trends in range and velocity that are consistent over time. Such trends can be used to indicate the presence of a moving object. If the trends are significant, which may be based on satisfaction or non-satisfaction of a certain threshold, then a highly educated determination can be made as to range, radial velocity and radial acceleration of a potential object. Once this information is determined, coherent processing can then be employed on the resultant data more efficiently.

In a third processing step 300, the measurement results from the incoherent processed radar data, which have preferably been analyzed by the measurement grouping and dynamical fitting algorithm(s) of the dynamic processing step 200, are used to perform coherent or correlator processing of the radar data. This can now be done more efficiently and effectively without the intense computational cost because the radar system now has a somewhat accurate fix on range, velocity and acceleration as a result of the incoherent processing 100 and the analysis performed by the measurement grouping and dynamical fitting algorithm(s) of the dynamic processing step 200.

In a fourth processing step 400, still further measurements and data fitting may be performed, but this time on the coherent or correlator processed radar data, similar to processing step 200. However, as this analysis is done using the coherent/correlator processed radar data, the signal-to-noise ratio of the data may be much higher, and the resulting measurements are more accurate in terms of range, velocity and acceleration. In the case of correlator processing, more accurate angular position measurements also result. This may ultimately allow the radar system to better identify and track the moving object(s), particularly where the object(s) was/were previously unidentified. As illustrated in FIG. 1, and as discussed in greater detail below, the correlator processed radar data can also be used for self-calibration of the receivers with respect to received phase.

According to some exemplary embodiments of this disclosure, one technological object is to provide a more efficient and effective process for identifying previously unknown space objects.

According to some exemplary embodiments of this disclosure, another technological object is to provide a more efficient and effective process for tracking now identified space objects.

According to some exemplary embodiments of this disclosure, still another technological object is to provide a more efficient and effective process for identifying and tracking space objects without the intensive computational costs of convention radar tracking systems.

In accordance with one aspect of the disclosure, some of the above and other objectives may be achieved by a method of processing radar data by a processor. The method comprises incoherently processing first radar data and, therefrom, identifying incoherent detections that exceed a noise threshold as a function of range and Doppler velocity. The method further comprises grouping incoherent detections, from amongst the identified incoherent detections, into a group of incoherent detections that correlate statistically to each other in range and Doppler velocity, and generating a fitted model for the group of detections, wherein the fitted model is defined by a range and Doppler space specifically reflective of the range and Doppler velocities of the incoherent detections in the group. The method then involves coherently processing second radar data over a plurality of range and Doppler spaces limited by the range and Doppler space corresponding to the fitted model associated with the group of incoherent detections, and identifying from the coherently processed second radar data a radar signal peak as a function of a range and Doppler velocity of a corresponding moving object.

In accordance with one aspect of the disclosure, some of the above and other objectives may be achieved by a radar system that comprises a radar reflector, a transmitter, an array of receivers, where each receiver is associated with a corresponding one of a plurality of receive channels, a memory and a processor configured to execute an algorithm embodied in a code stored in the memory. Further in accordance with the radar system, when the processor executes the algorithm embodied in the code stored in the memory, the radar system is configured to incoherently process first radar data and, therefrom, identify incoherent detections that exceed a noise threshold as a function of range and Doppler velocity; group incoherent detections, from amongst the identified incoherent detections, into a group of incoherent detections that correlate statistically to each other in range and Doppler velocity, and generate a fitted model for the group of detections, wherein the fitted model is defined by a range and Doppler space specifically reflective of the range and Doppler velocities of the incoherent detections in the group; and coherently process second radar data over a plurality of range and Doppler spaces limited by the range and Doppler space corresponding to the fitted model associated with the group of incoherent detections, and identify from the coherently processed second radar data a radar signal peak as a function of a range and Doppler velocity of a corresponding moving object.

### DESCRIPTION OF DRAWINGS

FIG. 1 illustrates an overview of the basic processing steps associated with exemplary embodiments of the present disclosure.

FIG. 2 is an exemplary radar system.

FIG. 3 illustrates the three primary processing modules or algorithms according to exemplary embodiments of the present disclosure.

FIG. 4(a)-FIG. 4(d) illustrate exemplary data processed by the three primary processing modules or algorithms according to exemplary embodiments of the present disclosure.

FIG. 5 illustrates the limitations on range/Doppler space for the incoherent processing algorithm of the present disclosure.

FIG. 6(a) and FIG. 6(b) illustrate a plurality of transmit (TX) pulses and receive (RX) signals over an incoherent processing time window Δt in accordance with exemplary embodiments of the incoherent processing algorithm of the present disclosure.

FIG. 7 is a flow diagram illustrating the basic incoherent processing algorithm, according to exemplary embodiments of the present disclosure.

FIG. 8 illustrates the extraction and storage of transmit pulses from the time series data according to exemplary embodiments of the incoherent processing algorithm of the present disclosure.

FIG. 9 illustrates the demodulation, filtering and down-sampling of the time series data according to exemplary embodiments of the incoherent processing algorithm of the present disclosure.

FIG. 10 illustrates the estimation of noise level and establishment of detection thresholds according to exemplary embodiments of the incoherent processing algorithm of the present disclosure.

FIG. 11 illustrates establishment of the power spectra for each range and RX time series data by performing a Fourier Transform on each RX time series data according to exemplary embodiments of the incoherent processing algorithm of the present disclosure.

FIG. 12 illustrates a range adjustment to the power spectra due to the movement of the space object according to exemplary embodiments of the incoherent processing algorithm of the present disclosure.

FIG. 13 illustrates the detection of SNR peaks in each range bin that exceed the detection threshold for each bin according to exemplary embodiments of the incoherent processing algorithm of the present disclosure.

FIG. 14 is a flow diagram illustrating the basic dynamic detection algorithm according to exemplary embodiments of the present disclosure.

FIG. 15 illustrates the time associated with a single measurement versus an entire coherent processing interval over many pulses of the present disclosure.

FIG. 16 is a flow diagram illustrating the basic coherent processing algorithm according to exemplary embodiments of the present disclosure.

FIG. 17 illustrates a plurality of range-Doppler windows that the coherent processing module will operate on to locate SNR peaks according to exemplary embodiments of the present disclosure.

FIG. 18 illustrates the mixing and demodulation steps according to exemplary embodiments of the coherent processing algorithm of the present disclosure.

FIG. 19 illustrates the filtering process according to exemplary embodiments of the coherent processing algorithm of the present disclosure.

FIG. 20 illustrates the process of remixing the time series data for the intermediate Doppler subset sweep according to exemplary embodiments of the coherent processing algorithm of the present disclosure.

FIG. 21 illustrates the process of further filtering and downsampling according to exemplary embodiments of the coherent processing algorithm of the present disclosure.

FIG. 22 illustrates the range interpolation process to account for the movement of the space object from one pulse to the next, according to exemplary embodiments of the coherent processing algorithm of the present disclosure.

FIG. 23 illustrates the generation of the power spectra of the receive time series data by applying an FFT to the time series data, according to exemplary embodiments of the coherent processing algorithm of the present disclosure.

FIG. 24 illustrates the extraction of the maximum Doppler peak to obtain range and Doppler at that range, according to exemplary embodiments of the coherent processing algorithm of the present disclosure.

FIG. 25 is a flow diagram that illustrates the basic correlation processing algorithm according to exemplary embodiments of the present disclosure.

FIG. 26 illustrates synthesizing an image of the sky in x and y coordinates from the complex visibility values, according to exemplary embodiments of the correlation processing algorithm of the present disclosure.

FIG. 27 is a diagram depicting the exemplary radar system, including a phased array, in communication with system memory and one or more processors of the present disclosure.

### DETAILED DESCRIPTION

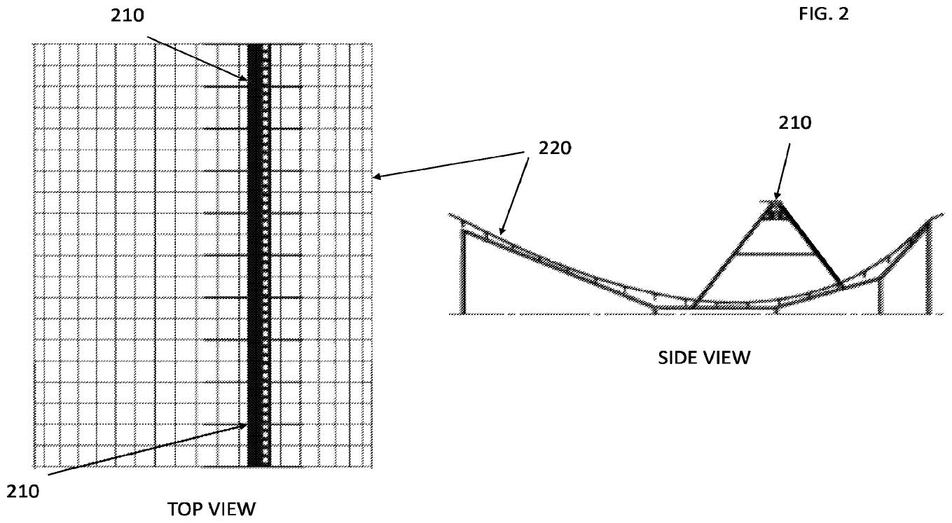

Generally, this disclosure describes methodologies for detecting and tracking space objects, including previously unidentified space objects. As those skilled in the art of radar and, in particular, the processing of radar data, the aforementioned methodologies can be implemented in various combinations of hardware, software, and/or firmware, and in conjunction with a radar antenna system, for example, the radar antenna system illustrated in FIG. 2. The exemplary radar antenna system illustrated in FIG. 2 comprises a phased array 210 that, in turn, comprises a plurality of receivers configured as a one-dimensional array. The exemplary radar antenna system also comprises a reflector, such as reflector 220 as shown. Those skilled in the art will readily appreciate that the present disclosure is not limited to a one-dimensional phased array system configuration.

The disclosure is now described in greater detail with references to the figures. The disclosure includes descriptions of exemplary embodiments, but those skilled in the art will understand that other embodiments are possible and within the intended scope of the disclosure as described herein and claimed.

Various terminology as used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, then there are no intervening elements present.

Various terminology as used herein is for describing exemplary embodiments, as mentioned above, and is not intended to be necessarily limiting of this disclosure. As used herein, various singular forms “a,” “an” and “the” are intended to include various plural forms as well, unless specific context clearly indicates otherwise. Various terms “comprises,” “includes” or “comprising,” “including” when used in this specification, specify a presence of stated features, integers, steps, operations, elements, or components, but do not preclude the presence or addition of one or more other features, integers, steps, operations, elements, components, or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized and/or overly formal sense unless expressly so defined herein.

Furthermore, relative terms, such as, for example, “below,” “lower,” “above,” and “upper,” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms, such as “below” and “lower,” can encompass both an orientation of above and below.

As used herein, a term “about” or “substantially” refers to a possible variation from a nominal value/term as those skilled in the art would understand it. Such variation is always included in any given value/term provided herein, whether or not such variation is specifically referred thereto.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Features described with respect to certain embodiments can be combined and sub-combined in and/or with various other embodiments. Also, different aspects and/or elements of embodiments, as disclosed herein, can be combined and sub-combined in a similar manner as well. Further, some embodiments, whether individually and/or collectively, can be components of a larger system, wherein other procedures can take precedence over and/or otherwise modify their application. Additionally, a number of steps can be required before, after, and/or concurrently with embodiments, as disclosed herein. Note that any and/or all methods and/or processes, at least as disclosed herein, can be at least partially performed via at least one entity in any manner.

In a preferred embodiment, the radar data processing pipeline described herein involves at least the following three processing modules or stages, as summarized above: (1) incoherent processing, (2) dynamic detection, and (3) coherent/correlator processing. In other exemplary embodiments, fewer than all three processing modules or stages may be involved. However, various combinations of these modules or stages result in increased sensitivity, as well as increased range, Doppler, and angular resolution, not achievable with incoherent processing, while maintaining faster processing throughput that is more typical of incoherent processing, not typical of coherent or correlator processing.

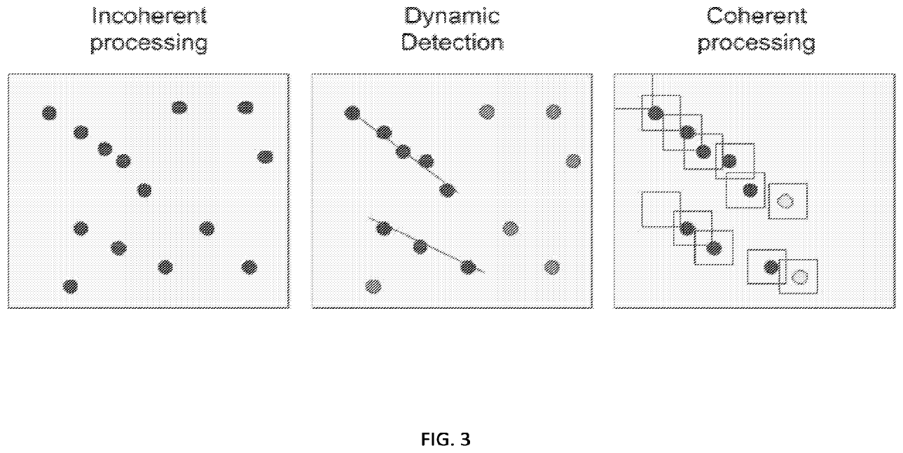

FIG. 3 illustrates the three processing modules or stages of the preferred embodiment of the radar processor pipeline: incoherent processing, dynamic detection and coherent/correlation processing. The left-most image represents the results of the incoherent processing stage. During the incoherent processing stage, the raw radar data is processed incoherently (without phase information) over a large volume of range and Doppler space based on many radar pulses over a period of time, otherwise referred to as “slow time.” The dots in the left-most image represent exemplary incoherent detections identified during the incoherent processing stage as a function of range (horizontal axis) and Doppler (vertical axis).

The middle image in FIG. 3 represents exemplary results of the dynamic detection stage. As shown, the same dots appear in the middle image as in the left-most image; however, during the dynamic detection stage, measurements are filtered using a dynamic detector to significantly reduce the false positive rate. The lines through certain dots in the middle image illustrate fitted models, thus identifying those detections that correlate statistically. The lighter dots which do not have lines running through them indicate what are rejected false positive detections.

The right-most image of FIG. 3 represents exemplary results from the coherent/correlation processing stage. During the coherent/correlator processing stage, additional processing focuses on regions of range and Doppler space identified during the dynamic detection stage. The lighter dots in the right-most image indicate additional processing of points on the edges of a group.

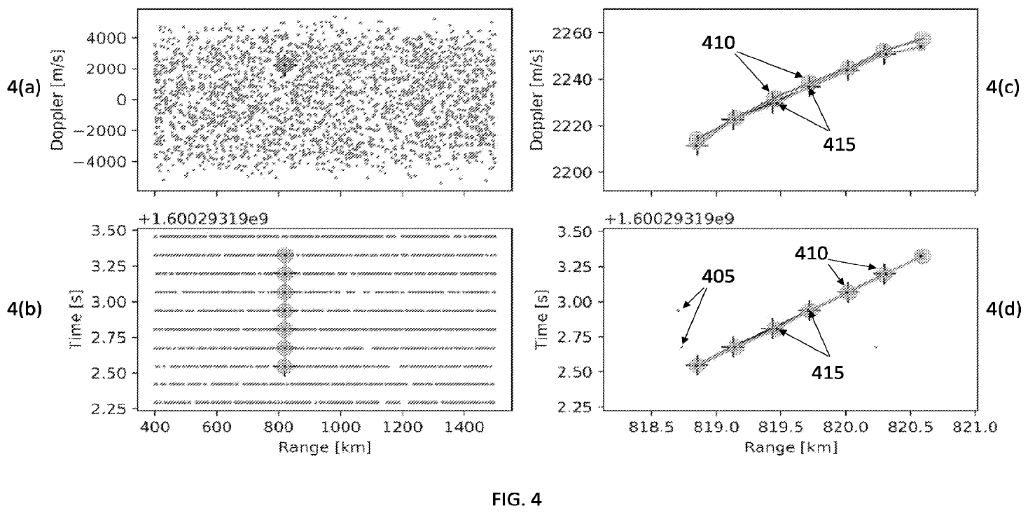

FIGS. 4(a) through 4(d) illustrate exemplary data fully processed following all three processing stages of the preferred embodiment. Briefly, FIGS. 4(a) and 4(b) present exemplary results as a function of range and Doppler after incoherent processing and dynamical detection processing. As shown, there is a great deal of radar data gathered during the faster incoherent processing stage; hence the benefit of performing the dynamic detection processing to eliminate a significant amount of what is likely to be false positive detections. After performing the dynamic detection processing, it is possible to more efficiently and accurately focus in on the positive detections during the coherent/correlation processing stage, the exemplary results of which are illustrated in FIGS. 4(c) and 4(d). As illustrated in FIGS. 4(c) and 4(d), the resulting data is more accurately defined in terms of range and Doppler.

In FIGS. 4(b) and 4(d), “Time” refers to slow time (defined above). The crosses in FIGS. 4(a) through 4(d) indicate measurements produced using traditional coherent processing techniques, which are included here for purposes of comparison. The small dots 405 in FIG. 4(d) indicate incoherent measurements (detections) produced during the incoherent processing stage, but were rejected during the dynamic detection stage. The large disks 410 indicate incoherent measurements that were selected during the dynamic detection stage and included in the model fitting process. The smaller disks 415 with black points indicate the result of the coherent processing stage output.

The three radar processing modules or stages of the preferred embodiment of the radar processing pipeline will now be described in greater detail.

### Incoherent Processing

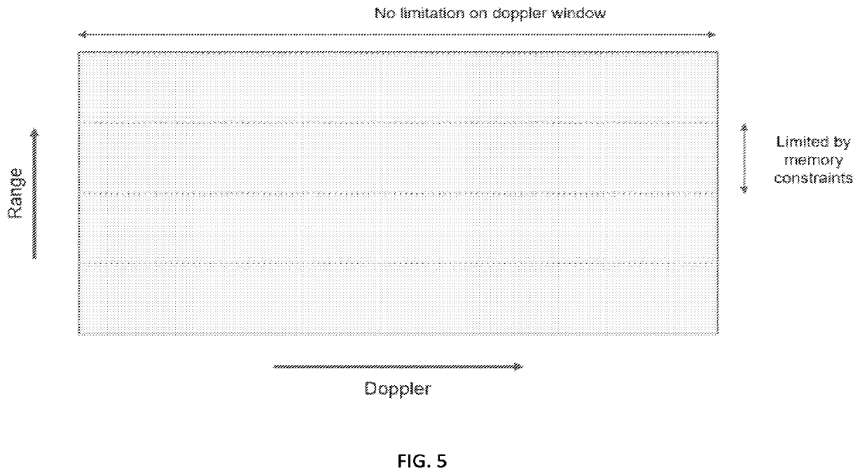

In accordance with a preferred embodiment of the radar processing pipeline described herein, incoherent processing is performed first. However, as mentioned above, other exemplary embodiments may differ, including embodiments that may employ incoherent processing at a time other than first, relative to the other processing modules or stages, or not at all. One reason for performing the incoherent processing first, according to the preferred embodiment, as opposed to coherent processing, is that the processing demands of incoherent processing are substantially less than those of coherent processing. This reduction in processing demand (e.g., computing costs) allows for the processing of a larger volume of range and Doppler space than would otherwise be possible with coherent processing alone. See, for example, FIG. 5 which illustrates the limitations on range and Doppler space. As shown, there is no limit on the Doppler window and the only limitation on range is the amount of memory set aside to store data. Because the processing demands are significantly reduced, incoherent processing of data can, if desired, be performed at all times according to exemplary embodiments of the present disclosure. Typically, incoherent processing would not be the only processing that is employed due to reduced sensitivity, as well as reduced range, Doppler, and angular precision compared with coherent processing. In the preferred embodiment, the reduction in precision and the reduction in sensitivity is addressed by the coherent/correlation processing module or stage 300.

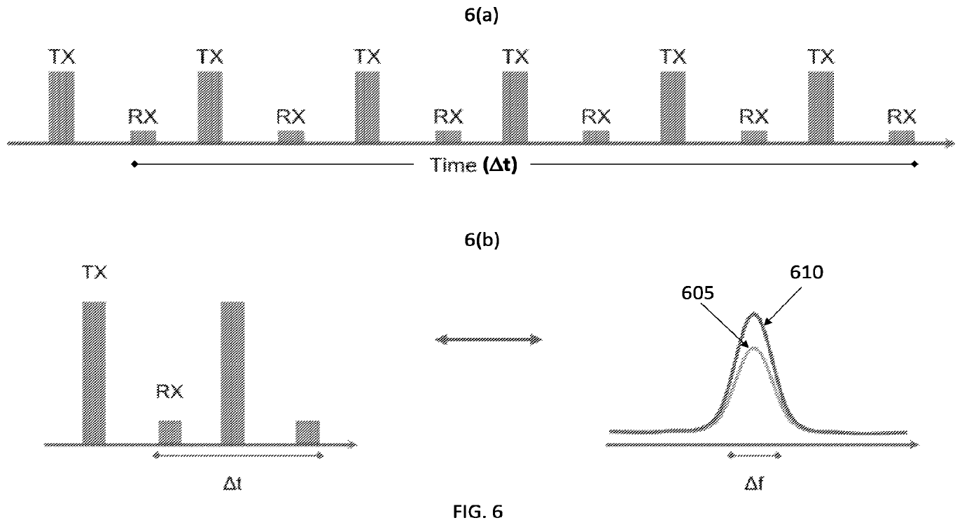

FIG. 6(a) illustrates a plurality of 6 transmit (TX) pulses and 6 receive (RX) signals over an incoherent processing time window Δt. The number of pulses in FIG. 6(a) is only illustrative. While incoherent processing is much faster (approximately 200× faster) than coherent processing, SNR is significantly less, making it more difficult to accurately identify and characterize detections. Thus, in incoherent processing, the number of pulses N may be particularly important because SNR scales as the square root of N in incoherent processing, whereas in coherent processing, SNR scales to N. Thus, for example, the SNR gain in incoherent processing with 5 pulses is 3.5 db, the SNR gain in coherent processing with 5 pulses is 7 db.

FIG. 6(b) only illustrates 2 TX pulses and 2 RX signals. The purpose of FIG. 6(b) is to illustrate that the number of pulses N, as explained in the previous paragraph, does improve SNR gain of the radar data, but it does not improve Doppler resolution (Δf). For the purpose of illustration, FIG. 6(b) shows two exemplary peaks 605 and 610, where peak 605 is associated with fewer pulses than peak 610. Despite the difference in the number of radar pulses, the width (i.e., the Doppler resolution) of the two peaks is the same, thus illustrating that there is no improvement in Doppler resolution from multi-pulse incoherent processing. Ultimately, the precision that is achieved by the incoherent processing module is a tradeoff with processing load (i.e., the number of pulses N processed over the incoherent processing time window).

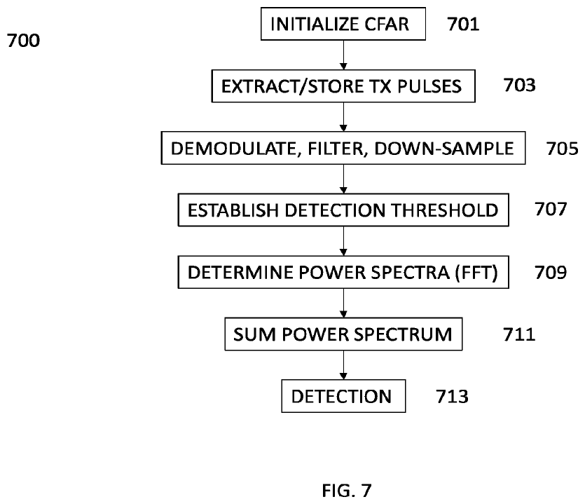

FIG. 7 is a flow diagram 700 illustrating the basic incoherent processing stage, according to exemplary embodiments of the present disclosure. In a first step 701, the system initializes a constant false alarm rate (CFAR). This depends on the expected noise level. The CFAR is essentially an internal threshold, wherein RX signals having an SNR above the threshold will be characterized as detections. As one skilled in the art will appreciate, some of these detections will be false detections, and the higher the threshold, the rate of false detections decreases, but the risk of missing a positive detection increases. The CFAR can be adjusted as additional data is collected and analyzed, and as noise levels change.

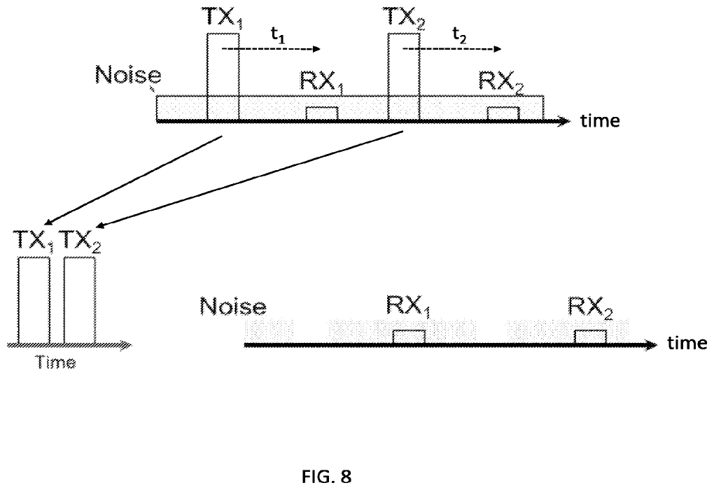

In step 703 of FIG. 7, the system extracts each of the TX pulses from the time series and stores them in memory. In FIG. 6, there were 6 TX pulses; however, for ease of discussion, there are 2 TX pulses TX₁ and TX₂ illustrated in FIG. 8. Each TX pulse TX₁ and TX₂, and corresponding RX signal RX₁ and RX₂, will be processed separately and, of course, incoherently. In memory, all TX pulses will be associated with a time zero relative to their corresponding RX signals. FIG. 8 illustrates the extraction of the two TX pulses of step 703. The times t₁ and t₂ between each pulse TX₁ and TX₂ and the corresponding RX signal, RX₁ and RX₂, respectively, in the time series represents the range of the detected space object from the radar transmitter/receiver system.

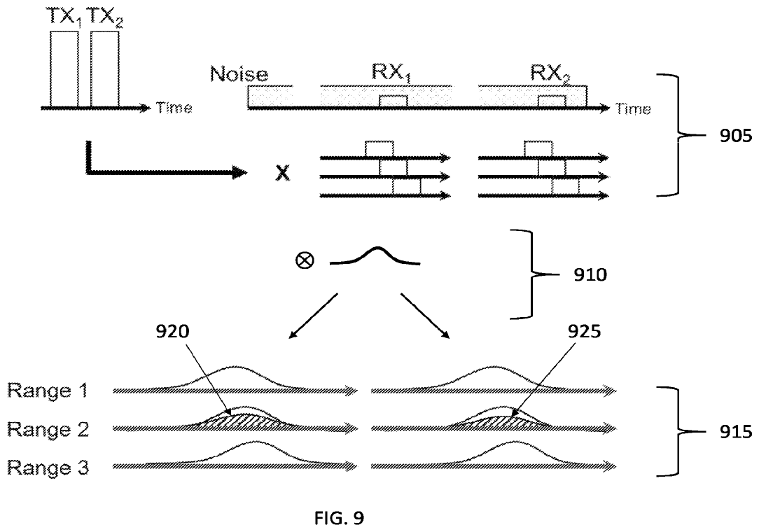

In step 705 of FIG. 7, the RX time series is demodulated, filtered and down-sampled. In a preferred embodiment, this can be accomplished all in one processing step. Processing the RX time series in a single processing step may avoid or minimize at least some needs for sparse arrays, as those skilled in the art will understand. In other exemplary embodiments, these functions may be accomplished in more than one processing step. FIG. 9 illustrates the demodulation, filtering and down-samplings step 705.

Referring to FIG. 9, demodulation, according to exemplary embodiments of this disclosure, involves multiplying each TX pulse (time zero) by the RX time series data that contains the RX signal corresponding to that TX pulse. The multiplication is accomplished with the TX pulse centered at a number of different ranges (times) along the corresponding RX time series. This is necessary because, at this point, the exact location of the corresponding RX signal is not known. The resulting data from the multiplication of TX₁, at 3 different ranges, by the corresponding RX time series data that contains RX₁, and the multiplication of TX₂, at the 3 different ranges, by the corresponding RX time series data that contains RX₂, is shown in FIG. 9 as process step 905. One skilled in the art will understand that more than or fewer than 3 ranges are possible. For the sake of perspective, the above described multiplication may be accomplished with the TX pulse centered at 1000 different ranges (times) along the corresponding RX time series in a more typical example.

The resulting data from the multiplication of TX₁, at each of the 3 different ranges, by the corresponding RX time series data that contains RX₁, and the resulting data from the multiplication of TX₂, at each of the 3 different ranges is then filtered, as illustrated by process step 910. In the preferred embodiment, filtering involves the use of one or more low pass filters. Filtering involves a convolution of the filter(s) with the resulting data from the preceding step, at each of the ranges.

The time series data, at each of the three ranges, for each TX pulse TX₁ and TX₂, data is down-sampled. As those skilled in the art will understand, down-sampling reduces the number of data points for processing purposes. The number of data points depends on the sampling rate. The time series data, after filtering and down-sampling is illustrated as processing step 915 in FIG. 9. As shown in FIG. 9, the data appears to be smoothed out over time. The “hashed” curves 920 and 925 that appear in the time series data at range 2 represent the RX signal corresponding to TX pulses TX₁ and TX₂, respectively.

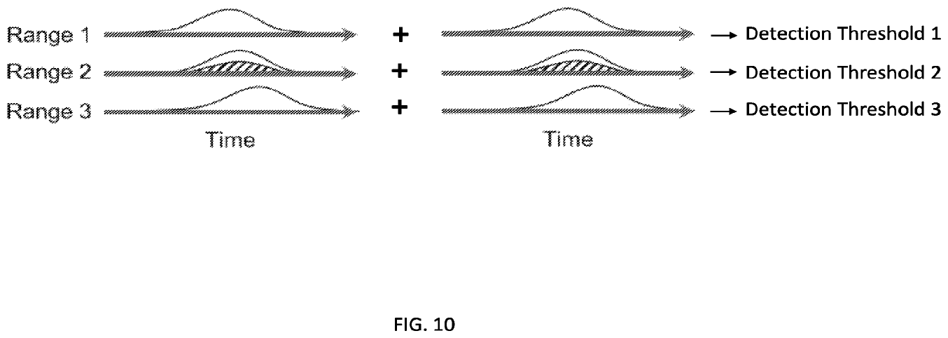

In step 707 of FIG. 7, noise level is estimated for each range and, therefrom, a detection threshold is established for each range, e.g., range 1, range 2 and range 3 in FIG. 9. In a preferred embodiment, this is achieved by summing the RX time series data from the previous step for each range, respectively. Alternatively, this can be achieved by summing and averaging the RX time series data from the previous step, for each range, respectively. This is illustrated in FIG. 10. Again, only the RX time series data corresponding to a first TX pulse TX₁ and a second RX time series data corresponding to a second TX pulse TX₂ are shown. One skilled in the art will understand that if the incoherent processing window involved more than 2 TX pulses, this processing step would involve summing RX time series data for more than 2 TX pulses for each range.

For each range, the total sum of the RX time series data provides a reasonable estimate of the noise level at that range. The noise level at each range is then adjusted, higher or lower, by a pre-calculated value that is determined based on statistical information that relates to known assumptions regarding the noise. The noise level is also adjusted based on the aforementioned false alarm rate. Ultimately, any signal that is above the detection threshold will, at least initially, be deemed a detection.

The reason it is necessary to determine a detection threshold for each range, for example, detection threshold 1, detection threshold 2 and detection threshold 3 as illustrated in FIG. 10, is that the noise level (i.e., the area under each curve in FIG. 10) can vary from range to range, as is known in the art. Noise is present for many reasons. The most common sources of noise are ground clutter, transient electronic noise, self-clutter and transmit/receive vignetting.

Determination of the detection thresholds can be accomplished during other stages of incoherent processing. In a preferred embodiment, it would actually be accomplished during the detection stage 713 of FIG. 7, which is described below.

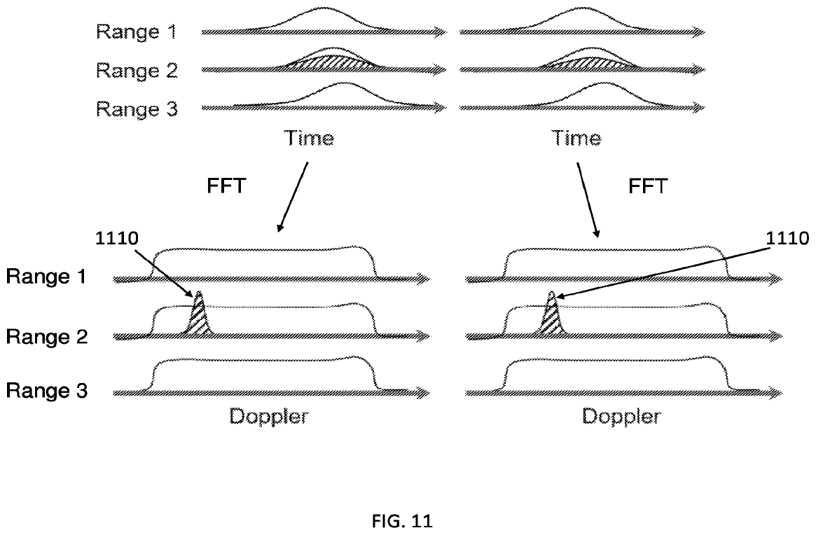

In step 709 of FIG. 7, the power spectra for each range and RX time series data corresponding to each TX pulse is obtained. This is accomplished by performing a Fourier Transform on each RX time series data for each range, as illustrated in FIG. 11. The resulting data is the power spectrum, which is the square of the amplitude, along a frequency (Doppler) axis rather than a time axis. The “hashed” peaks 1105 and 1110 in the power spectrum data of FIG. 11 represent the RX signal associated with transmit pulses TX₁ and TX₂, respectively, in the frequency domain. It is worth noting that because this processing stage involves incoherent processing, phase information is not only ignored, it is eliminated because it is computationally expensive to maintain it.

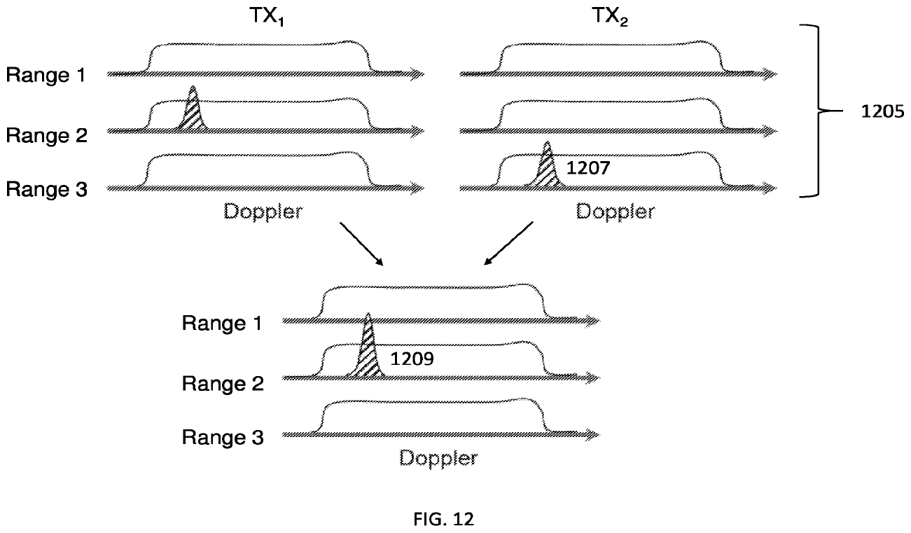

In step 711 of FIG. 7, the incoherent processing module takes the incoherent sum of the power spectra of all the pulses. However, before the incoherent processing module takes the sums, it is necessary to adjust the range of the RX signal associated with each TX pulse after the first TX pulse. The reason this is necessary is that the object moves quite a bit along its orbit even in the short amount of time between the first TX pulse TX₁ and the second TX pulse TX₂, and each TX pulse thereafter. This is commonly known as range migration. Therefore, prior to taking the incoherent sums, the incoherent processing module performs a range interpolation to adjust the range of the object, in the power spectrum, for each TX pulse after the first TX pulse, in order to take into consideration the movement of the space object. This adjustment step is illustrated by process step 1205 in FIG. 12.

In the description of the coherent processing module below, range interpolation will again be discussed. However, the coherent processing module performs this adjustment in the time series data, whereas here, the incoherent processing module performs the adjustment in the power spectrum and assumptions regarding constant Doppler values and constant radial velocities are not an issue.

Performing the range adjustment here in the power spectrum involves analyzing changes in the Doppler velocity of each TX pulse subsequent to the first TX pulse and, based on the changes in Doppler velocity, determine whether the RX signal in the power spectrum should appear at a different range, i.e., whether the RX signal in the power spectrum should be moved to a nearer range bin or a farther range bin. In the example of FIG. 12, the Doppler velocity of the RX signal 1207 associated with pulse TX₂ results in the RX signal being adjusted from range 2 to range 3, again to adjust for range migration.

Once the incoherent processing module makes the range adjustments, the power spectrum for all of the pulses are incoherently added together, based on each respective TX pulse being transmitted at time zero. In the example of FIG. 12, there are only two pulses TX₁ and TX₂. As illustrated, Rx signals that relate to a same space object add together, for example, RX signal peak 1209 in FIG. 12, resulting in a higher amplitude peak.

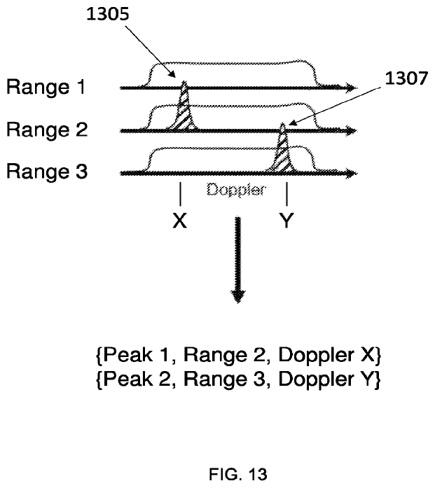

In step 713 of FIG. 7, the incoherent processing module searches through each of the range bins and Doppler velocities for RX signals that exceed the detection thresholds established for each range in processing step 707. In FIG. 13, for purposes of illustration only, the incoherent processing module detects RX signal two peaks 1305 and 1307. The incoherent processing module can store these detections in various forms as one skilled in the art will appreciate. Again, for purposes of illustration, FIG. 13 shows the data associated with each detection being stored as a set of data values: Peak, Range, Doppler. While the illustration in FIG. 13 includes only two detections, it will be understood that the incoherent processing module can produce many detections. In the example illustrated in FIG. 3, the incoherent processing module produced far more than two detections.

In a preferred embodiment, the incoherent processing module will, as part of the detection step 713, prior to storing the set of data values for each detection, fine tune the Doppler peaks by performing a quadratic interpolation, which essentially fills in Doppler values between data samples. This interpolation step may result in a shifting of the Doppler velocity. It could also result in a higher amplitude peak. Also, in a preferred embodiment, the incoherent processing module will, as part of the detection step 713, prior to storing the set of data values for each detection, consolidate the detections by sorting through all of the detections, for example, according to signal level, and possibly remove duplicate detections. After fine tuning the Doppler peaks and consolidating the detections, the incoherent processing module can store the data sets for each remaining detection, as described above. This data will then be processed by the dynamic detection module, which is described in detail herein below.

### Dynamic Detection Processing

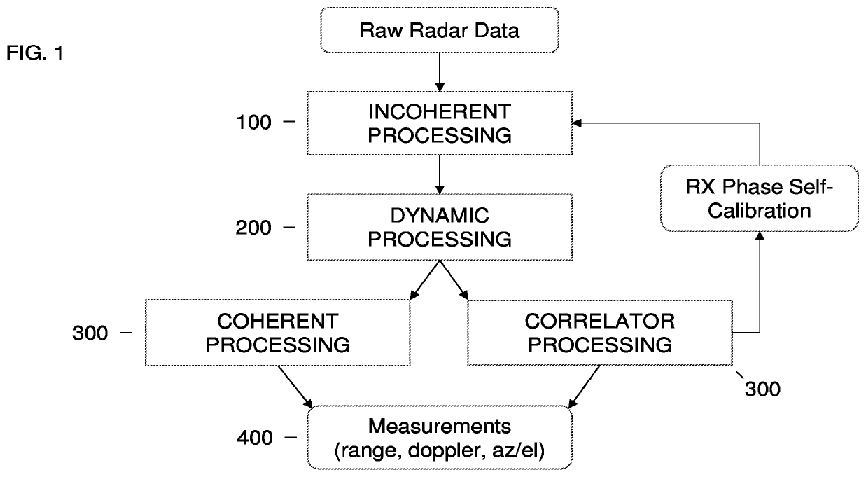

In accordance with a preferred embodiment of the radar processing pipeline described herein, a dynamic detection processing step 200, as shown in FIG. 1, is performed after the incoherent processing step 100 described above and before any coherent and/or correlation processing, which described in detail later. In fact, the input to the dynamic detection processing step (or module) 200 is the output from the incoherent processing step 100.

As explained above, the output of the incoherent processing step 100 is a plurality of data sets, where each data set represents a possible target detection and, in accordance with a preferred embodiment, includes a value for range, Doppler and peak SNR. The number of data sets that are output by the incoherent processing step 100 is typical very large, as illustrated in FIG. 4(a), and it is, at least in part, a function of the aforementioned CFAR which essentially sets the sensitivity level of the incoherent processing step 100. As previously explained, when the CFAR threshold is set to a relatively low value, the sensitivity of the incoherent processing step 100 increases, thereby allowing more measurements to be characterized as possible target data, but at the expense of having more false positives.

Thus, the primary function of the dynamic detection processing step 200 is to take a large batch of data sets (i.e., the data sets output by the incoherent processing step), which is likely to include a significant number of false positives, and sort through all of the data sets to find combinations of data sets that together look like a real target. While one measurement, i.e., one data set, in isolation is not going to be considered a target, two, three or more data sets that fit some physical model may reflect a target, or candidate target, with a higher probability than a single data set that is not eliminated by the CFAR. Finding all of the combinations of related data sets is, however, computationally intractable due to the sheer quantity of data. The dynamic detection processing module algorithm(s) comprises two particularly key features to deal with the large quantity of data that should be analyzed. Briefly, the two features involve (1) the use of SNR data from the data sets to seed the formation of a group of potentially related data sets around a physical model that reflects the measurements associated with the data sets belonging to the group, and (2) iteratively fine tuning the group and the physical model by identifying candidate data sets that have measurement values (range and Doppler) that are nearby the physical model of the group. Both features will now be explained in more detail.

The first feature, or step, in the dynamic detection process, involves selecting a likely data set that best represents a possible group of data sets. The concept here is to single out one specific data set to start. In a preferred embodiment, this involves the use of SNR. More specifically, the dynamic detection module identifies one data set amongst all the data sets that has the maximum SNR measurement.

This initial data set, having the maximum SNR, also has a corresponding range measurement and Doppler measurement, as do all of the data sets. The dynamic detection module then builds a physical model, which is a polynomial fit, based on at least the range and Doppler measurements of this initial data set as well as a theoretical estimate of Doppler acceleration for targets in low Earth orbit. Since the physical model is based on the measurements associated with the initial data set, it can be said that that initial data set is “on top” of the physical model, or stated otherwise, zero (0) distance from the physical model, and all candidate data sets that are potentially associated with this first group of data sets will be identified based on their respective distance from the physical model in terms of range and Doppler.

Once the initial data set has been identified and the physical model established, the second feature is to iteratively refine the group by identifying candidate data sets whose measurements are statistically close to the physical model of the corresponding group. To determine whether a candidate data set is close to the physical model, the dynamic detection module computes the “distance” of the candidate data set from the model in terms of measured range and Doppler. In a preferred embodiment, the distance that is calculated is known as the Mahalanobis Distance, which is well known in the art as a distance between the model and a distribution (each of the data sets that are potentially associated with the group), normalized by estimated uncertainties, due to instrumentation precision, in the model and the data points associated with each of the data sets.

While it is possible to process candidate data sets in parallel, in a simplest case, only one candidate data set is processed at a time to determine if it is nearby the model. In a preferred embodiment, the first data set is the one with the maximum SNR, as explained above. Thereafter, the measurements of many data sets should be considered; however, the one whose distance is next closest to the model is identified and the measurements of this next closest data set are used to iteratively update or fit a new model based on the measurements of the initial data set and the next closest data set. So now, the model is based on the measurements of more than one data set. If the two data sets are indeed coming from the same target, then they should satisfy a physical model that relates the range, Doppler and acceleration at all times.

As this is an iterative process, the dynamic detection process is continuously repeated, whereby additional candidate data sets whose measurements are nearby the corresponding model are identified and used to update or fit a new model. In some exemplary embodiments, updating or fitting a new model can be terminated and the process continues only in that additional candidate data sets are determined to be nearby the model or not. The entire process terminates when the process reaches a certain number of iterations or when the process can no longer identify any data sets whose measurements are sufficiently close to the model.

As stated, the number candidate data sets for a given grouping may be very large. Thus, in accordance with a preferred embodiment, a pre-filter is applied to reduce the computational load. To do this, a filter is used to pre-select candidate data sets whose measurements were sufficient to get past the CFAR (defined above), but still somewhat distant from the physical model. This pre-filter essentially removes outlier data sets from the grouping before the iterative process of considering candidate data sets begins.

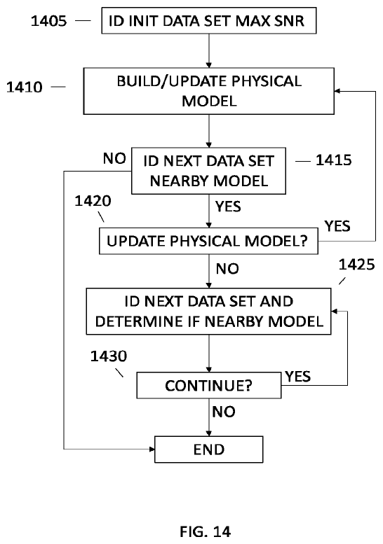

FIG. 14 is flowchart that summarizes the dynamic detection process for establishing a group of data sets around a physical model. As shown, a first step 1405 in the process is to identify an initial data set having the maximum SNR measurement among other data sets. In a next step 1410, the measurements (range, Doppler and estimated Doppler acceleration) associated with the initial data set are used to construct a physical model. Thereafter, additional candidate data sets may be identified, as illustrated by step 1415, and their distance (e.g., the Mahalanobis Distance) from the physical model in terms of range, Doppler and estimated Doppler acceleration will be determined. The measurements associated with one or more of the candidate data sets can then be used to update the physical model, as shown by the YES path out of step 1420. The above described steps may then be repeated until there is no longer any value in updating the physical model, for example, the changes to the physical model are negligible in consideration of additional candidate data sets, or until there are no further candidate data sets to consider. When this occurs, the process proceeds according to the NO path out of step 1420 and step 1425. On the other hand, if there are additional data sets to consider, even though the physical model need not be further updated, the process continues according to the YES path out of step 1430, unless and until there are no further data sets to be considered, at which point, the process with respect to this specific grouping of data sets ends.

Once the dynamic detection process establishes this first group of data sets, the data sets associated with this first group are saved, and the dynamic detection process proceeds to identifying a next grouping of data sets in a manner identical to the process described above. Thus, the dynamic detection module identifies a next data set having a maximum SNR among the remaining data sets is identified and used to seed a second group of data sets that may relate to a second target. The next data set is then used to construct a second physical model and additional candidate data sets are identified, based on their respective distance from the model, and used to update the second physical model. As described above, the process repeats for a certain number of iterations or until the process can no longer identify any additional data sets whose measurements are sufficiently close to the model.

The overall dynamic detection process continues until a set or maximum number of data set groups have been identified or the module simply runs out of data to process. In addition, while the dynamic detection process detects one group of data sets at a time, it is within the scope of the present disclosure for the dynamic detection process to detect more than one group of data sets at a time, i.e., in parallel. And, those skilled in the art will understand that an implementation that detects groups in parallel can be achieved simply by employing greater processing power.

In a preferred embodiment, after each group of data sets has been established, a final iteration of rebuilding the model and accepting or rejecting candidate data sets is accomplished. In this final iteration, a different threshold is used to fit all of the data. Thus, it is possible to reject a data set that was previously accepted if the measurements associated with the data set are not sufficiently close to the model base on the new threshold. At the end of the dynamic detection process, each group of data sets and the corresponding physical model represent a potential target. And, the parameters that define the physical model of each of the groupings, respectively, serves as the input to the coherent processing step or correlator processing step 300, which will be described in detail herein below.

### Coherent/Correlator Processing

After the data set groups have been identified and fitted (modeled) in the dynamic detection step 200, as described above, the parameters that define each of the physical models of each grouping are used for focused coherent/correlator processing. One of the key features of the overall process is the in the coherent/Correlator processing step, processing of raw radar data involves focusing processing resources on specific regions identified as a result of the incoherent processing step 100 and the dynamic detection processing step 200. In general, the range and Doppler values of potential targets, as defined by the parameters associated with the physical models generated during the dynamic detection processing step 200, are used to significantly reduce the volume of range and doppler space that algorithm(s) should process during coherent/correlator processing. Thus, after coherent/correlator processing, the range, Doppler and angular resolution of measurements is significantly improved relative to the measurements obtained from the incoherent processing step 100. The fitted acceleration values from the dynamic detection processing step 200 are also used to reduce the prevalence of Doppler outliers. The disclosure herein below begins with a description of the coherent processing module.

The coherent processing module, and the algorithm(s) that make up the coherent processing module, involves processing several pulses together including phase information. The processing occurs in “fast time.” Fast time refers to the processing of the radar time series data within a single measurement. The actual time is set by the sampling rate of the analog-to-digital converters (ADCs), as those skilled in the art will appreciate. Fast time is contrasted with “slow time,” which refers to the processing time over all of the measurements which may involve many pulses.

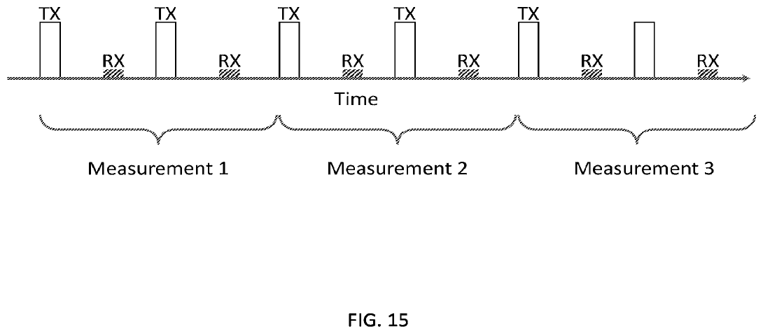

FIG. 15 illustrates multiple measurements, each corresponding to an entire coherent processing interval. The overall length of time encompassing the multiple measurements represents the dwell time. As those skilled in the art will appreciate, more pulses result in greater Doppler resolution (i.e., finer, more narrow and distinct peaks), which makes it easier to determine the center frequency of the Doppler information, and obtain a more accurate measurement of Doppler shift. However, more pulses may require more processing power, so there may be a tradeoff.

More pulses also translates into greater SNR measurements. As explained above, with coherent processing, coherent SNR scales as N, Incoherent SNR scales to the square root of N. Thus, for the same number of pulses, coherent SNR measurements are significantly higher than incoherent SNR measurements.

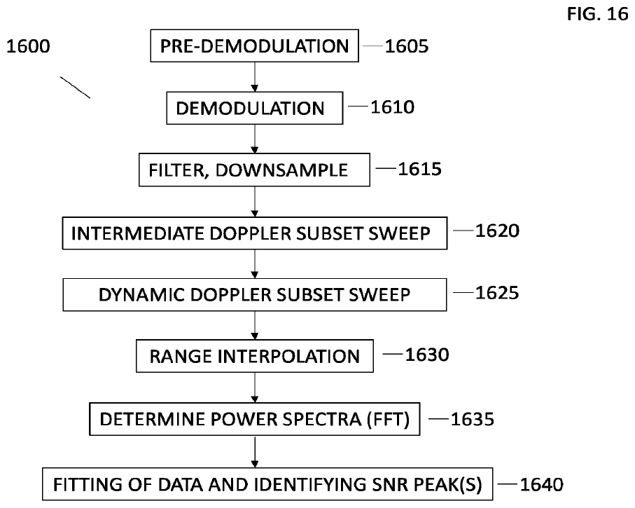

FIG. 16 is a flowchart that illustrates the basic coherent processing algorithm 1600. Briefly, the algorithm involves a demodulation step 1605, a filter/downsample step 1610, an FFT step 1615 and an SNR peak detection step 1620. The SNR peak detection step 1620 involves separating the time series data into different range bins and for each one, sweeping through the frequencies looking for SNR peaks. The process is enhanced, in terms of efficiency, by the fact that algorithm knows where in these range-Doppler windows to look for target data because of the physical model parameters of potential targets that were provided to the coherent processing module by the incoherent processing module and the dynamic detection module.

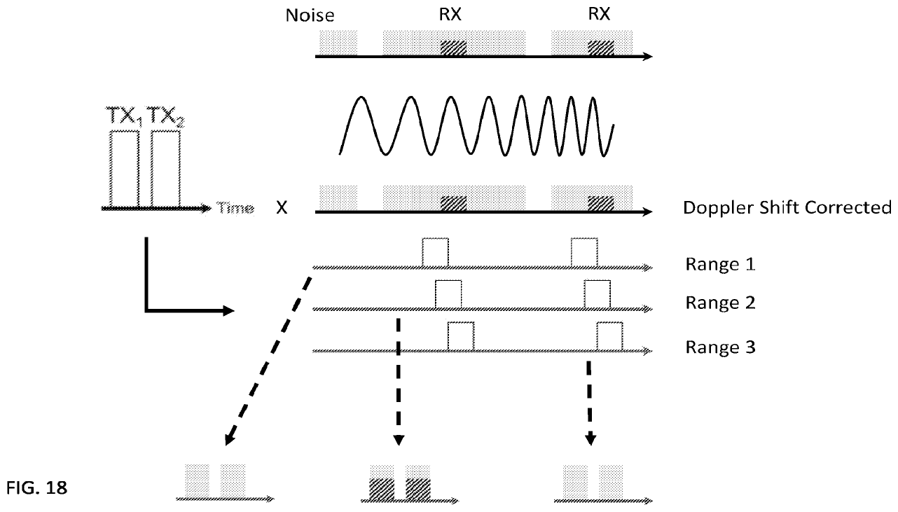

More specifically, with regard to the aforementioned efficiency, the physical model parameters of potential targets provided by the incoherent processing module and the dynamic detection dynamic module amounts to a fitted range, Doppler, and acceleration value for a given measurement. The coherent processing algorithm uses the Doppler and acceleration in the mixing step, prior to demodulation, in order to correct (i.e., center) the desired signal at baseband. This is described in more detail below and illustrated in FIG. 18 as Doppler shift corrected. The fitted range value, on the other hand, is used by the coherent processing algorithm to determine which time delays to use during the demodulation step, as time delay maps to range via the speed-of-light.

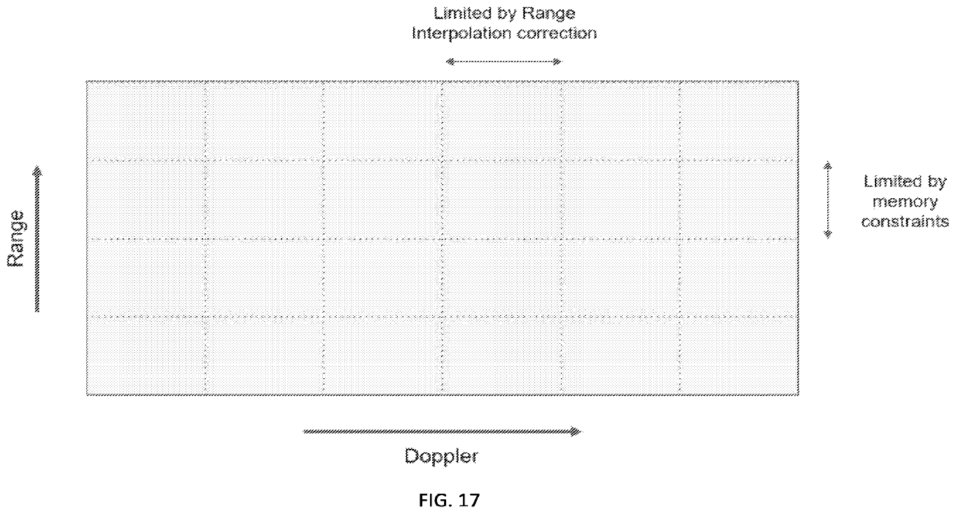

FIG. 17 illustrates a plurality of range-Doppler windows that the coherent processing module will operate on to locate SNR peaks. In a preferred embodiment, the coherent processing module sweeps through one or more of the range bins separately searching for SNR peaks. However, it is within the scope of the present disclosure to perform the processing in parallel with the use of a graphics processing unit (GPU), a field-programmable gate array (FGPA), multiple parallel processors, a specialized application specific integrated chip (ASIC), or the like, as will be evident to a skilled artisan.

In a first step 1605 of the coherent processing algorithm, a number of pre-demodulation steps are performed. In accordance with this step, transmit pulses, for example, transmit pulses Tx₁ and Tx₂ from a given measurement are extracted from the radar data and stored in memory. Even though the transmit pulses were transmitted at different times, they are both stored at a designated time zero (0) in memory. This is similar to the step performed by the incoherent processing module and illustrated in FIG. 8, which was described above.

Further in accordance with pre-demodulation step 1605, a correction for changes in the Doppler shift of the moving object is performed. This may be important because the radial velocity of the moving object or target is changing as it moves across the sky. To make this correction, the time series radar return data is mixed with a complex sine wave, which is a function of the radial velocity of the moving object and radial acceleration. This is illustrated in FIG. 18. The sine wave may additionally be a function of higher time derivatives of the moving object's radial position, such as the first and second derivatives of the radial acceleration. Even higher time derivatives may be used. If the moving object is known, that is, it has already been identified and registered in the system, the radial velocity and acceleration of the object is known, and the complex sine wave can be synthesized based on this information. If the moving object is not yet registered, the data from the incoherent and dynamic detection processing steps are used to synthesize the complex sine wave. As a result of this correction, the time series data can now be demodulated and filtered, as will be explained in more detail below.

The next step performed by the coherent processing algorithm is demodulation of the time series data, as illustrated by step 1610 in FIG. 16. The demodulation process is illustrated in FIG. 18. As shown, for each of a number of range bins, the complex conjugate of the transmit pulses of the current measurement is multiplied by the receive time series data. In the example of FIG. 18, there are two transmit pulses TX₁ and TX₂ and three range bins. If there is no signal data in a given range bin, the resulting product of the demodulation will be noise only, as is the case for range 1 and range 3 in the example of FIG. 18. However, if there is signal data associated with a moving object, it will show up as a peak in the resulting, modulated time series data. This is illustrated by the modulated time series data from range 2 in FIG. 18. In a preferred embodiment, the resulting, modulated time series data is stored in a sparse array to save memory.

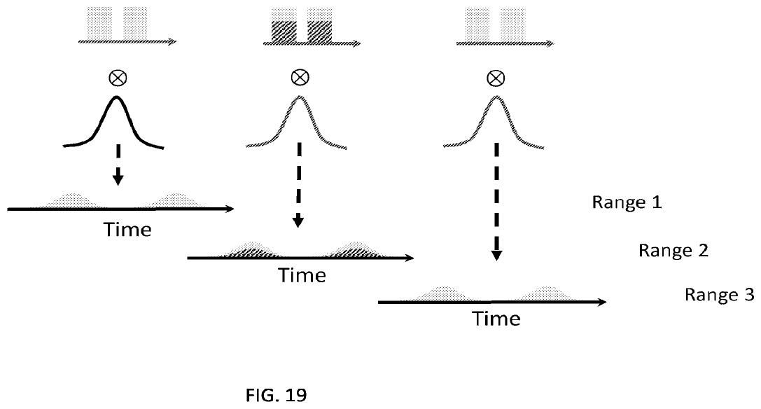

In step 1615, the resulting, demodulated time series data associated with each range bin is filtered. In a preferred embodiment, this involves convolution of each resulting, modulated time series data with a low pass filter, followed by a downsampling of the filtered data. The downsampling, as one skilled in the art will appreciate, results in fewer data samples and faster processing. FIG. 19 illustrates the filtering process. As shown, the filtering causes what appears to be a stretching of the data in each range bin over time.

At this point, the coherent processing algorithm remixes the time series data for each range bin, and then filters and downsamples the resulting data. In a preferred embodiment, the algorithm repeats this at least two times. With each repetition, the size of the Doppler window in each of the ranges is reduced. In FIG. 16, the two repetitions are referred to as the intermediate Doppler subset sweep 1620 and the dynamic Doppler subset sweep 1625.

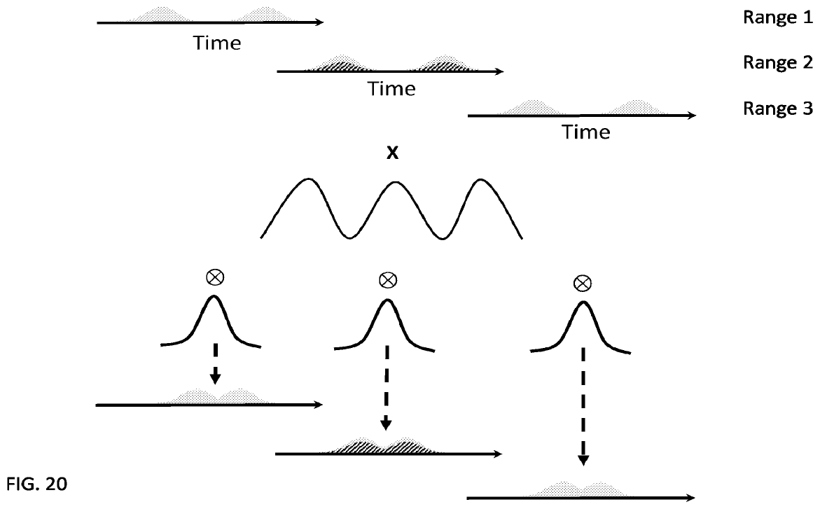

FIG. 20 illustrates the process of remixing the time series data for the intermediate Doppler subset sweep. As shown, this involves multiplying the current time series data with a sine wave that is a function of the central Doppler velocity of the intermediate Doppler windows. However, unlike the pre-demodulation step 1605 described above, there is no acceleration correction. Also illustrated in FIG. 20 is the low pass filtering of the resultant time series data, followed by a downsampling of the data, which results in the SNR peak of the radar return signal becoming more prominent, as illustrated.

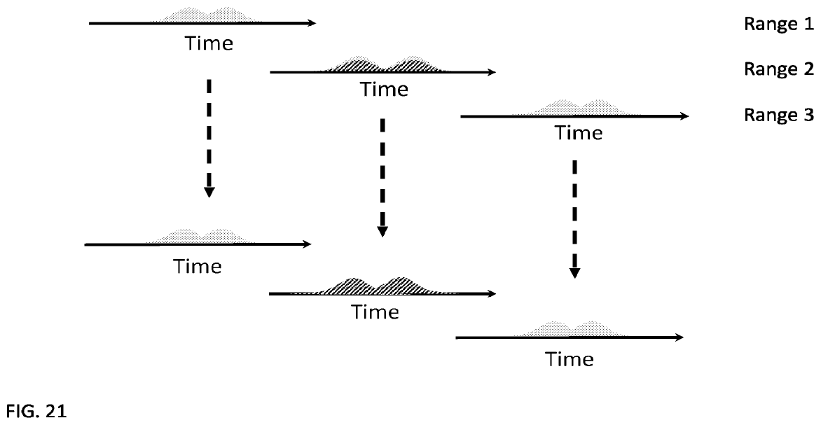

The coherent processing algorithm similarly remixes the time series data for the dynamic Doppler subset sweep. This involves multiplying the time series data from the intermediate Doppler subset sweep with a sine wave that is a function of the central Doppler velocity of the dynamic Doppler windows. Again, there is no acceleration correction. Further low pass filtering is applied, followed by a downsampling of the data, which results in the SNR peak of the radar return signal becoming even more prominent, as illustrated in FIG. 21.

In step 1630, of FIG. 16, the coherent processing algorithm performs a range interpolation. The range interpolation is essentially an adjustment of the range measurement for radar return signals in the time series data after the first radar return signal, i.e., the radar return signal associated with the first transmit pulse. The reason this is necessary is that the moving object is moving so quickly across the sky that each successive radar return signal will have a different delay relative to its corresponding transmit pulse. These differences in radar return signal delay manifest themselves as different ranges. So, in order to be able to perform the FFT on the time series data, in a later step, and accurately add the peaks together in the frequency domain, we should first adjust for these differences in range.

It should be noted that the range interpolation is performed after the size of the Doppler windows have been minimized in accordance with the previous steps. This may be important because the range accuracy degrades the closer the radar return signal is to the boundary of the Doppler window. The accuracy problem is minimized by having smaller Doppler windows centered on zero frequency.

Within a given Doppler sub-window, the coherent processing algorithm can assume that any detected targets will have some fixed Doppler velocity (which is the center Doppler velocity for the given Doppler sub-window). For the time series data, every subsequent time step corresponds to the signal at a different time delay. Using this time delay, the coherent processing algorithm can calculate the total time between when the measurement started and when the received power for this time step reflected off of the target. The algorithm then multiplies that total time by the Doppler velocity to obtain an expected change in range of the target between the start of the measurement and this time step.

Next, for every time delay, the coherent processing algorithm constructs a numerical kernel that will weight neighboring range bins according to the expected change in range for that time delay. By convolving the data set along the range axis with this kernel, the signal for a given range is moved to the range bin that it would have been in had there been no change in range due to the Doppler velocity. It should be noted that this correction kernel will be different for each time step in the time series, as each time step corresponds to a different time delay.

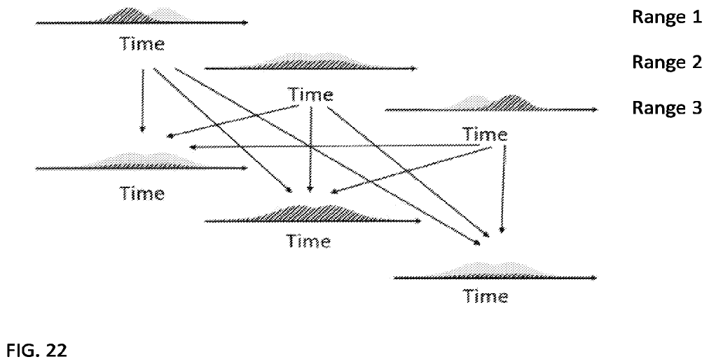

The above range interpolation can be applied through direct convolution, or via multiplication in the range-Fourier domain. Skilled engineers will understand how this works. The range interpolation process is illustrated by FIG. 22.

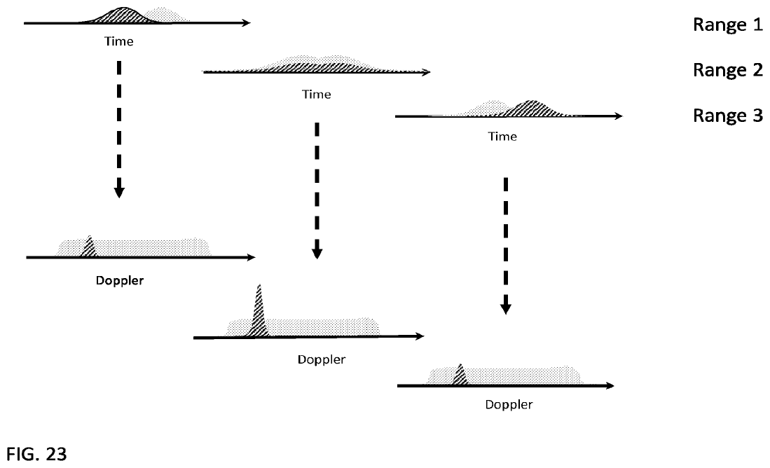

Once, the range correction has been completed by virtue of the range interpolation step 1630, the coherent processing algorithm determines the power spectra of the time series data by performing an FFT on the time series data, as set forth in step 1635 of FIG. 16. FIG. 23 illustrates the FFT step 1630 more specifically. As shown, the FFT is performed on the time series data at each of the range bins. This step is similar to step 709 which is performed by the incoherent processing algorithm, as illustrated in FIG. 7.

In a final step, according to a preferred embodiment, the coherent processing algorithm performs a parabolic data fitting procedure, in order to more accurately obtain the data associated with the Doppler peak. This is shown in FIG. 16 as step 1640. The Doppler spacing between data points is determined by the length of the FFT. As those skilled in the art will appreciate, it is possible to achieve finer Doppler spacing by increasing the FFT length (which is achieved by zero-padding the time-series data). However, as those skilled in the art also know, this can be computationally expensive. The interpolation or parabolic data fitting procedure provides a good trade-off between computational cost and resulting Doppler precision. As illustrated in FIG. 23, the interpolation or parabolic data fitting procedure adjusts the maximum Doppler value of each Doppler peak to reflect a more accurate maximum peak value.

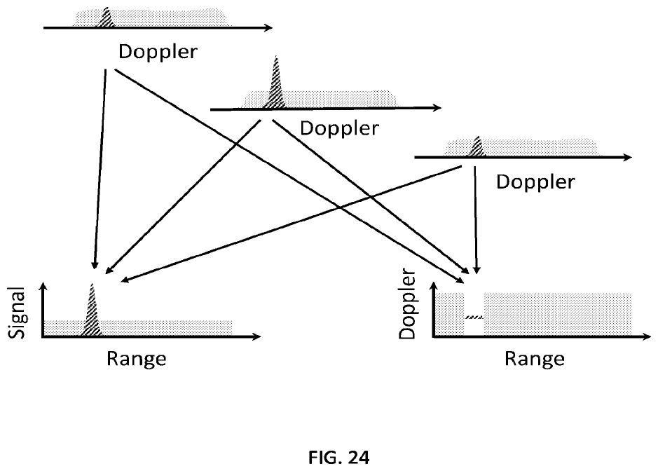

The coherent processing algorithm then extracts the Doppler peak at the indicated range from the Doppler window that has the maximum value compared to the Doppler peaks in all of the other Doppler windows. Thus, as illustrated in FIG. 24, the coherent processing algorithm obtains, for the moving target, a range to the object and the Doppler value at that range.

The above described coherent processing algorithm, as previously explained, executes the same processing steps for each measurement of each moving target based on the information provided by the incoherent processing algorithm and the dynamic detection algorithm. The same information can be provided to the correlation processing algorithm, which is now described herein below.

In the above description of the coherent processing algorithm, multiple pulses are transmitted and multiple return signals are received in the time series data. There was no mention of the number of channels, i.e., the number of receivers receiving the return signals. However, it is assumed that only one receiver is employed to receive the multiple return signals in the time series data, even if the radar system, such as the radar system illustrated in FIG. 2, comprises multiple receivers. When the radar system does employ multiple receivers and is capable of processing multiple channels of radar data, the time series data described above with respect to the coherent processing algorithm can instead be processed by a different module referred to herein as the correlator processing module or algorithm.

The correlation processing algorithm may be more sophisticated than the coherent processing algorithm, and the correlation processing algorithm may provide greater Doppler resolution and higher SNR than coherent processing. As stated above, the correlation processing algorithm may require multiple receivers. As a result of the multiple receivers, the correlation processing algorithm may be capable of processing angular information in addition to range and Doppler information. In contrast, the coherent processing algorithm measured only range and Doppler. It should be noted, when the radar system employs multiple receivers, the coherent processing algorithm described above could use some or all of the multiple receivers to coherently process the time series data. In accordance with alternative embodiments of the present disclosure, the coherent processing algorithm could essentially add up the multiple time series data associate with each receiver and then process the time series data in the same manner as described above. The additional receivers essentially provide additional data sets for more accurately determining the range and Doppler characteristics of a given moving object.

In general, the correlation processing algorithm coherently processes one or more radar pulses across a plurality of receive channels, and determines SNR peaks across a fixed window of range, Doppler, azimuth and elevation; the azimuth and elevation being the angular information mentioned above. While the coherent processing algorithm specifically assumes multiple radar pulses, the correlator processing can occur with single-pulse across multiple channels, as mentioned above. The correlator processing steps for one pulse is the same as correlator processing for multiple pulses. We should make the case of single-pulse correlator sensing explicit

There are two general features associated with the correlation processing algorithm, according to exemplary embodiments of the present disclosure. The first feature involves the use of interferometry to calculate a highly precise position of a moving target on the sky. More specifically, this involves determining the phase difference of the receive signals between two (e.g., adjacent) separate receive channels and, from the phase differences, estimate the phase correlations, also known as “visibilities” by those skilled in the art, of the receive signals. The inverse Fourier Transform of the phase correlations can then be used to generate a synthesized image which provides a distribution of the receive power on the sky. From this distribution, the moving object can be identified by the peak power in the distribution and the position estimated from the synthesized image. The process will be described in greater detail below.

The second feature involves self-calibration. The receive signal associated with each of the receive channels is subject to phase errors. The phase errors are due to calibration errors and random noise. Based on the sky signal model generated by the interferometry feature described above, the correlation processing algorithm can predict expected receive phase values for each receive channel. The difference between predicted and measured receive phase values allows the correlation processing algorithm to estimate the phase errors for each receive channel. These estimated phase errors can be used for self-calibration of each of the receive channels in future measurements.

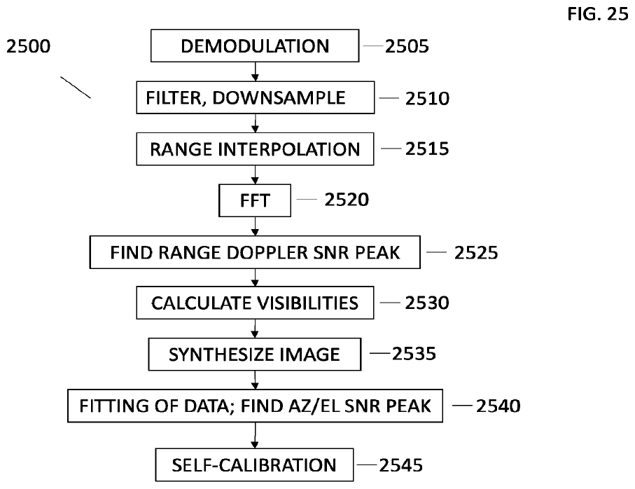

FIG. 25 is a flowchart that illustrates the process that is executed by the correlation processing algorithm. As illustrated, the process generally involves a demodulation step 2505, a filter and downsample step 2510, a range interpolation step 2515, a Fast Fourier Transform step 2520, an SNR peak(s) identification step 2525, a visibilities calculation step 2530, a synthesize image step 2535, an azimuth/elevation determination step 2540 and a self-calibration step 2545. It should be noted that in accordance with a preferred embodiment, the first five steps executed by the correlation processing algorithm, that is, the demodulation, filtering and downsampling, range interpolation, Fast Fourier Transform (FFT) and SNR peak(s) identification steps 2505-2525, are performed in an identical manner as the demodulation step 1610, filter and downsample step 1615, range interpolation step 1630, FFT step 1635 and SNR peak(s) identification step 1640 of the correlation processing algorithm, except that in accordance with the correlation processing algorithm, these steps are performed for each of the multiple receive channels. Thus, each of the interpolated range/Doppler data values for each of the multiple receive channels taken together reflects a set of per-channel complex spectral values for the multiple receive channels. And, in describing the correlation processing algorithm below, the description will start with the calculate visibilities step 2530, which is unique to the correlation processing algorithm, with the understanding that (1) the first five preceding steps of the correlation processing algorithm have been executed for each of the multiple receive channels in a manner that is the same or substantially similar to the corresponding steps performed by the coherent processing algorithm and (2) the resulting range/Doppler data values for each of the multiple receive channels is stored for use in executing the remaining steps of the correlation processing algorithm, as described herein below.

Referring back to FIG. 16, step 2530 involves calculating the visibility for each pair of receive channels. If the number of receive channels (receivers) is n, then the total number of pairs of receive channels is n*(n−1)/2. Calculating the visibility for each of the receive channel pairs involves multiplying the complex spectral signal (i.e., the output of the FFT step) at the range/Doppler position, obtained by performing the first five steps of the correlation algorithm, by the complex conjugate of the spectral signal of the other receive channel of the pair, also obtained by performing the first five steps of the correlation algorithm. The visibility, or complex visibility, of a given pair of receive channels represents the phase difference between the two receive channels that make up the pair.

As those skilled in the art will understand, the calculated, complex visibilities, for all receive channel pairs, reflect the Fourier Transform of the positions on the sky in a two-dimensional plane, referred to herein as the UV plane, for a corresponding moving object. The dimensions U and the V are a function of the change in physical distance (i.e., the separation) between the receivers of each receive channel pair in X and Y coordinates on the ground and the wavelength k of the carrier frequency of the radar beam. More specifically, U and V for a given complex visibility value can be defined as ΔX/λ=U and ΔY/λ=V, respectively, where ΔX is the physical distance separating the two receivers of the corresponding receive channel pair in an X direction on the ground and ΔY is the physical distance separating the two receivers of the corresponding receive channel pair in a Y direction on the ground. It will be appreciated that all of the complex visibility values together result in a grid of complex visibility values in the UV plane.

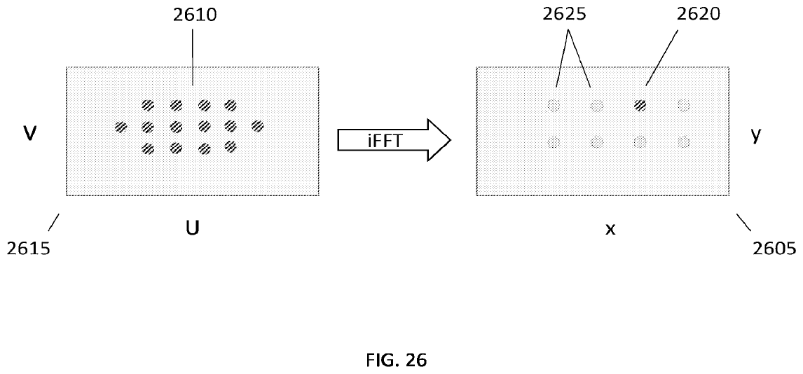

As illustrated in FIG. 25, the next step 2535 of the correlation algorithm is to take the UV grid of complex visibility values and, therefrom, synthesize an image of the sky in x and y coordinates. This is illustrated in FIG. 26. The x and y coordinates illustrated in FIG. 26 are different from the X and Y coordinates discussed above which relate to the physical position on the ground of the receivers associated with each of the receive channels. In contrast, the x and y coordinates illustrated in FIG. 26 represent angular positions relative to the center of the radar beam. Synthesizing the image 2605 in FIG. 26, in x and y coordinates, is accomplished by performing a two dimensional inverse FFT (iFFT) on the complex visibility value of each receive channel pair 2610 in the UV plane 2615. In the synthesized image, the darkened point 2620 is the location of peak SNR value, which represents the position of the moving target in angular coordinates x and y relative to the center of the radar beam. The lighter points 2625 in the synthesized image illustrate the possible locations of sidelobes which have SNR values that are less than the peak SNR value. Hence, they appear lighter in color in the synthesized image of FIG. 26.

As shown in FIG. 25, the next step that is performed by the correlation processing algorithm is the data fitting and peak SNR determination step 2540. The algorithm essentially searches for the maximum peak SNR value in the synthesized image and performs a parabolic interpolation, which is the same or similar to the process that was performed by the coherent processing algorithm. This fitting of the SNR data provides a more accurate x and y position for the peak SNR value, which is likely to be a sub-pixel position proximate to the darkened point 2620.

Further, in accordance with step 2540, azimuth and elevation values are derived from the x and y position of the maximum SNR value, after the parabolic interpolation. In a preferred embodiment, the azimuth and elevation values and the x and y positions are maintained. As one skilled in the art will know, azimuth and elevation can be derived by applying a standard frame rotation or spherical trigonometry technique to the x and y coordinate values.

The self-calibration step 2545, is actually an optional step. In a preferred embodiment, the self-calibration is performed every time the correlation processing is performed. However, while the self-calibration improves the sensitivity of the receive data across the multiple receive channels, one skilled in the art will appreciate that the self-calibration can, alternatively, be performed periodically, rather than every time the correlation processing is performed. Still further, the self-calibration may never be performed, of course, with the understanding that the receive data will be less sensitive.

The self-calibration step 2545, in part, depends on the X and Y values in the UV plane discussed above. As explained, each of the plurality of X and Y values, as illustrated, for example, in FIG. 26, reflects an expected or predicted phase difference between the two receive channels that make up the corresponding one of the receive channel pairs. The self-calibration also depends, in part, on the interpolated range/Doppler per-channel complex spectral values, determined by the first five steps of the correlation processing algorithm, ending with step 2525, which also reflect the phase of the corresponding receive channel. More particularly, the self-calibration step 2545 involves calculating, for each one of the multiple receive channels, a residual phase value which is a function of the expected phase value of the one receive channel relative to the a reference receive channel, and a function of the complex spectral value of the one receive channel relative to the reference receive channel, where the reference receive channel can be any of the multiple receive channels. In other words, the selection of a reference receive channel is arbitrary; however, for processing convenience, it may be preferable to select a receive channel near the center of the array. But this does not affect accuracy of the correlation processing algorithm.

By way of example, if a first receive channel is the designated reference receive channel, the residual phase value is essentially zero, because it is the reference channel. However, for a second receive channel, the expected phase difference is reflected by the corresponding XY position for the first-second receive channel pair. The complex spectral value for the second receive channel pair is obtained by determining the phase difference of the spectral value of the first receive channel and the spectral value of the second receive channel. The residual phase value for the second receive channel, relative to the reference receive channel (i.e., the first receive channel), is thus determined by the difference of (1) the expected phase difference of the second receive channel (i.e., the phase associated with the XY position for the first-second receive channel pair) and (2) the complex spectral value of the second receive channel pair. The residual phase value can be calculated in an identical for each of the other receive channels relative to the reference receive channel.

As mentioned above, the residual value calculated for each receive channel can be applied to subsequently received radar data received by the corresponding receive channel to improve the sensitivity of that receive channel. Further, as previously mentioned, the residual phase values for each receive channel can be updated every time the correlation processing algorithm is executed. Alternatively, the residual phase values for each receive channel can be updated periodically, for example, once over a predetermined time period, or it is possible to never calculate or update the residual phase values, despite having the data to do so from the correlation processing algorithm.

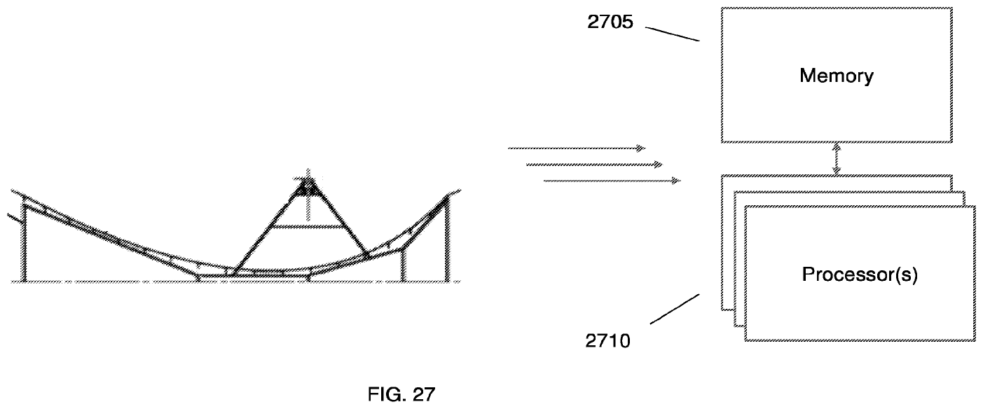

FIG. 27 is a diagram depicting the exemplary radar system of FIG. 2, including the phased array 210, in communication with system memory 2705 and one or more processors 2710. In view of the preceding disclosure, it will be apparent that the variously described algorithms, such as the incoherent processing algorithm, the dynamic detection algorithm, the coherent processing algorithm, the correlation processing algorithm and the self-calibration algorithm, maybe stored in the memory 2705 and executed by the one or more processors 2710, to achieve the results described above. FIG. 27 is not intended to limit the disclosure above to a particular hardware design or configuration. Those skilled in the art will recognize that various hardware designs and/or configurations are possible without departing from this disclosure, including the various embodiments described herein above, or the claims set forth below.

The disclosure presented above, describes a radar data processing pipeline that improves the overall process of identifying and thereafter tracking objects, particularly objects not previously identified, moving in space through a combination of incoherent, dynamic detection, coherent and/or correlator processing techniques, as well as data analysis and fitting to identify and track objects more accurately, while minimizing the computational expense that is typical of such systems. While the disclosure includes reference to preferred embodiments, exemplary embodiments and/or alternative embodiments, it will be understood and appreciated that other embodiments are conceivably and within the scope and spirit of the above disclosure.

1. A method of processing radar data, the method comprising:
incoherently processing, via a processor, first radar data and, therefrom, identifying, via the processor, incoherent detections that exceed a noise threshold as a function of range and Doppler velocity;
grouping, via the processor, incoherent detections, from amongst the identified incoherent detections, into a group of incoherent detections that correlate statistically to each other in range and Doppler velocity, and generating, via the processor, a fitted model for the group of detections, wherein the fitted model is defined by a range and Doppler space specifically reflective of the range and Doppler velocities of the incoherent detections in the group; and
coherently processing, via the processor, second radar data over a plurality of range and Doppler spaces limited by the range and Doppler space corresponding to the fitted model associated with the group of incoherent detections, and identifying, via the processor, from the coherently processed second radar data, a radar signal peak as a function of a range and Doppler velocity of a corresponding moving object.

2. The method of claim 1, wherein coherently processing, via the processor, the second radar data comprises:
correcting, via the processor, the second radar data for changes in Doppler shift of the moving object by mixing the second radar data with a complex sine wave that is a function of a radial velocity and radial acceleration of the moving object.

3. The method of claim 2, wherein the complex sine wave is also a function of higher time derivatives of the radial position of the moving object.

4. The method of claim 3, wherein, when the moving object is a known object, the radial velocity and radial acceleration of the moving object are known.

5. The method of claim 3, wherein, when the moving object is not previously known, the radial velocity and radial acceleration of the moving object are estimated from the fitted model.

6. The method of claim 2, further comprising:
demodulating, via the processor, the Doppler shift corrected second radar data in each of a number of range bins; and
filtering, sampling and remixing, each via the processor, the demodulated second radar data a plurality of times, wherein remixing the second radar data for each of the number of range bins comprises multiplying, via the processor, the demodulated, filtered and sampled data by a sine wave that is a function of the central Doppler velocity of the given range bin, and wherein with each remixing, the size of the range bins decreases.

7. The method of claim 6, further comprising:
adjusting, via the processor, the range measurement of the demodulated second radar data to correct for time delays due to the movement of the moving object between radar pulses.

8. The method of claim 1, wherein the coherent processing, via the processor, of the second raw radar data comprises:
coherently processing, via the processor, the second radar data for each of a plurality of receive channels.

9. The method of claim 8 further, comprising:
for each pair of receive channels that make up the plurality of receive channels, determining, via the processor, a phase difference between the coherently processed radar data of the two receive channels that make up each pair of receive channels;
calculating, via the processor, visibility values for each pair of receive channels;
synthesizing, via the processor, a distribution of receive power on the sky corresponding to the position of the moving object as a function of the inverse Fourier Transform of the visibility values;
determining, via the processor, a maximum peak signal in the synthesized distribution of receive power on the sky; and
determining, via the processor, azimuth and elevation values of the moving target based on the maximum peak value.

10. The method of claim 9, wherein determining, via the processor, the maximum peak signal comprises:
performing, via the processor, data interpolation between data samples.

11. The method of claim 9, wherein determining, via the processor, the azimuth and elevation values of the moving target comprises:
a frame rotation, via the processor, of the coordinate value corresponding to the maximum peak signal in the synthesized distribution of receive power on the sky.

12. The method of claim 9, further comprising:
calculating, via the processor, for each of the plurality of receive channels, a residual phase value, wherein the residual phase value for a given receive channel is a function of an expected phase value of the receive channel relative to an expected phase value of a reference receive channel, and a function of a complex spectral value of the receive channel relative to a complex spectral value of the reference receive channel, and wherein the expected phase value of the given receive channel relative to the expected phase value of the reference receive channel is a function of the physical distance between a receiver of the given receive channel and a receiver of the reference receive channel, and a wavelength of the radar beam carrier frequency.

13. The method of claim 12, further comprising:
calibrating, via the processor, one or more of the plurality of receive channels based on the corresponding residual phase value.

14. A radar system comprising:
a radar reflector;
a transmitter;
an array of receivers where each receiver is associated with a corresponding one of a plurality of receive channels;
a memory and a processor configured to execute an algorithm embodied in a code stored in the memory, wherein, when the processor executes the algorithm embodied in the code stored in the memory, the radar system is configured to:
incoherently process first radar data and, therefrom, identify incoherent detections that exceed a noise threshold as a function of range and Doppler velocity;
group incoherent detections, from amongst the identified incoherent detections, into a group of incoherent detections that correlate statistically to each other in range and Doppler velocity, and generate a fitted model for the group of detections, wherein the fitted model is defined by a range and Doppler space specifically reflective of the range and Doppler velocities of the incoherent detections in the group; and
coherently process second radar data over a plurality of range and Doppler spaces limited by the range and Doppler space corresponding to the fitted model associated with the group of incoherent detections, and identify from the coherently processed second radar data a radar signal peak as a function of a range and Doppler velocity of a corresponding moving object.

15. The radar system of claim 14, wherein coherently processing the second radar data comprises:
correcting the second radar data for changes in Doppler shift of the moving object by mixing the second radar data with a complex sine wave that is a function of a radial velocity and radial acceleration of the moving object.

16. The radar system of claim 15, wherein the complex sine wave is also a function of higher time derivatives of the radial position of the moving object.

17. The radar system of claim 16, wherein, when the moving object is a known object, the radial velocity and radial acceleration of the moving object are known.

18. The radar system of claim 16, wherein, when the moving object is not previously known, the radial velocity and radial acceleration of the moving object are estimated from the fitted model.

19. The radar system of claim 15, wherein the radar system is further configured to:
demodulate the Doppler shift corrected second radar data in each of a number of range bins; and
filter, sample and remix the demodulated second radar data a plurality of times, wherein remixing the second radar data for each of the number of range bins comprises multiplying the demodulated, filtered and sampled data by a sine wave that is a function of the central Doppler velocity of the given range bin, and wherein with each remixing, the size of the range bins decreases.

20. The radar system of claim 19, wherein the radar system is further configured to:
adjust the range measurement of the demodulated second radar data to correct for time delays due to the movement of the moving object between radar pulses.

21. The radar system of claim 14, wherein the coherent processing of the second raw radar data comprises:
coherently processing the second radar data for each of a plurality of receive channels.

22. The radar system of claim 21, wherein the radar system is further configured to:
for each pair of receive channels that make up the plurality of receive channels, determine a phase difference between the coherently processed radar data of the two receive channels that make up each pair of receive channels;
calculate visibility values for each pair of receive channels;
synthesize a distribution of receive power on the sky corresponding to the position of the moving object as a function of the inverse Fourier Transform of the visibility values;
determine a maximum peak signal in the synthesized distribution of receive power on the sky; and
determine azimuth and elevation values of the moving target based on the maximum peak value.

23. The radar system of claim 22, wherein determining the maximum peak signal comprises:
performing data interpolation between data samples.

24. The radar system of claim 22, wherein determining the azimuth and elevation values of the moving target comprises:
a frame rotation of the coordinate value corresponding to the maximum peak signal in the synthesized distribution of receive power on the sky.

25. The radar system of claim 21, wherein the radar system is further configured to:
calculate, for each of the plurality of receive channels, a residual phase value, wherein the residual phase value for a given receive channel is a function of an expected phase value of the receive channel relative to an expected phase value of a reference receive channel, and a function of a complex spectral value of the receive channel relative to a complex spectral value of the reference receive channel, and wherein the expected phase value of the given receive channel relative to the expected phase value of the reference receive channel is a function of the physical distance between a receiver of the given receive channel and a receiver of the reference receive channel, and a wavelength of the radar beam carrier frequency.

26. The radar system of claim 25, wherein the radar system is further configured to:
calibrate one or more of the plurality of receive channels based on the corresponding residual phase value.
